(19) United States
(12) Patent Application Publication
(10) Pub. No.: US 2011/0191813 A1
(43) Pub. Date: Aug. 4, 2011

(54) USE OF PICTURE-IN-PICTURE STREAM FOR INTERNET PROTOCOL TELEVISION FAST CHANNEL CHANGE

(76) Inventors: Mike Rozhavsky, San Jose, CA (US); Kunal R. Shah, Mountain View, CA (US)

(21) Appl. No.: 12/700,631

(22) Filed: Feb. 4, 2010

(51) Int. Cl. H04N 7/173; H04N 5/45

(52) U.S. Cl. 725/110; 348/565; 725/116; 725/119; 725/131; 370/390; 348/E05.112

(57) ABSTRACT

A method and apparatus of controlling an Internet Protocol television (IPTV) channel change to a first multimedia stream of an IPTV channel, where the channel change is initiated by a set top box coupled to the network device is described. A network device receives a request from a set top box for a high-resolution multimedia stream from a device downstream and transmits a low-resolution multimedia stream upstream in place of the high-resolution multimedia stream request. The network device receives the low-resolution multimedia stream and forwards the low-resolution stream to the requesting set top box. The set top receives the low-resolution stream and displays this stream. Furthermore, the network device transmits the high-resolution multimedia stream request and receives the high-resolution multimedia stream. The set top box receives the high-resolution multimedia stream and displays this stream.

### BACKGROUND

1. Field

Embodiments of the invention relate to the field of processing network traffic; and more specifically, to the using a picture-in-picture stream for an Internet Protocol Television (IPTV) fast channel change.

2. Background

Internet Protocol Television (IPTV) allows for the viewing of television (TV) programs on an Internet Protocol (IP) network. In many IPTV setups, the IP network uses multicast protocols for delivering content. When content is displayed through IPTV, a set top box (STB) sends a request message to the multicast router in order to receive the requested TV programs. This request causes a state change in the router and the router forwards the requested IPTV traffic stream associated with the requested TV program to fill a buffer in the set top box. The data in the buffer is decoded and the content from the decoded data is displayed to the user.

Typically in an IPTV system, it takes 1.3-2.0 seconds to changes a channel. A channel change time is defined as the time the set top box makes a request for a multimedia stream (e.g., a request to receive a multimedia stream for a television program) to the time the set top box starts to display the received multimedia stream. There are other solutions known in the art that attempt to improve on this channel change time. One fast channel change solution reduces the channel change time to 0.8-1.1 seconds. This solution works by having a separate caching server that caches the desired TV program. When a request comes for an IPTV multimedia stream, the router forwards that stream from the caching server starting with an I-frame. As known in the art, an I-frame is an “intra-coded picture,” which is a fully specified picture, like a conventional static image. In order to decode and construct a correct picture on the screen of a display coupled to the host, it is important for set top box decoder to receive an I-frame as soon as possible. When a channel change request is received by the router, the buffered stream for that channel that begins the I-frame In addition, the caching server is transmitted at a higher than normal rate to fill the buffer in the host so that the content of the initial I-frame can be decoded and displayed.

The disadvantage of this standard method and the fast channel change is that these methods still take about one second or more to change the channel. Furthermore, the fast channel change method requires a large buffer on the caching server to store sufficient data to support the fast channel change. In addition, the slow channel change reduces the overall quality of the IPTV experience.

### SUMMARY

A method and apparatus of controlling an Internet Protocol television (IPTV) channel change to a first multimedia stream of an IPTV channel, where the channel change is initiated by a set top box coupled to the network device is described. A network device receives a request from a set top box for a high-resolution multimedia stream from a device downstream and transmits a low-resolution multimedia stream upstream in place of the high-resolution multimedia stream request. The network device receives the low-resolution multimedia stream and forwards the low-resolution stream to the requesting set top box. The set top receives the low-resolution stream and displays this stream. Furthermore, the network device transmits the high-resolution multimedia stream request and receives the high-resolution multimedia stream. The set top box receives the high-resolution multimedia stream and displays this stream.

In one embodiment, the method operates by receiving a request for the first multimedia stream from the set top box. The method further transmits, with the network device, a request for a second multimedia stream, where the second multimedia stream corresponds to the same IPTV channel as the first multimedia stream and the second multimedia stream has a lower resolution that the first multimedia stream. The method receives the second multimedia stream and transmits the second multimedia stream to the set top box. In addition, the method transmits a request for the first multimedia stream and receives the first multimedia stream.

In another embodiment, a network comprises a set top box and a network device. The set top box requests an Internet Protocol television (IPTV) channel change to a first multimedia stream of an IPTV channel using a request to receive the first multimedia stream.

The network element is coupled to the set top box and comprises a multimedia stream receiving component, low-resolution request component, low resolution receiving component, low-resolution transmission component, high-resolution request component, high resolution receiving component, and a switching component. The multimedia stream receiving component receives the request for the first multimedia stream from the set top box. The low-resolution request component transmits a request for a second multimedia stream and the second multimedia stream corresponds to the same IPTV channel as the first multimedia stream and the second multimedia stream has a lower resolution that the first multimedia stream. The low-resolution receiving component receives component receives the second multimedia stream. The low-resolution receiving component receives the low-resolution multimedia stream. The low-resolution transmission component transmits the second multimedia stream to the set top box. The high-resolution request component transmits a request for the first multimedia stream. The high-resolution request component receives the first multimedia stream.

In another embodiment, a network element is adapted to control access by a set top box to a first multimedia stream of an Internet Protocol television (IPTV) channel. The set top box is coupled to the network element and initiates an IPTV channel change to the first multimedia stream.

The network element comprises a multimedia stream receiving component, low-resolution request component, low resolution receiving component, low-resolution transmission component, high-resolution request component, high resolution receiving component, and a switching component. The multimedia stream receiving component is to receive the request for the first multimedia stream from the set top box. The low-resolution request component is to transmit a request for a second multimedia stream and the second multimedia stream corresponds is to the same IPTV channel as the first multimedia stream and the second multimedia stream has a lower resolution that the first multimedia stream. The low-resolution receiving component is to receive the second multimedia stream. The low-resolution transmission component is to transmit the second multimedia stream is to the set top box. The high-resolution request component is to transmit a request for the first multimedia stream. The high-resolution receiving component is to receive the first multimedia stream

### BRIEF DESCRIPTION OF THE DRAWINGS

The invention may best be understood by referring to the following description and accompanying drawings that are used to illustrate embodiments of the invention. In the drawings:

FIG. 1 illustrates a network capable of delivering IPTV service to a host according to one embodiment of the invention;

FIG. 2 (prior art) illustrates a timeline of a channel change for a standard implementation of IPTV;

FIG. 3 (prior art) illustrates a channel change for a fast channel change of IPTV;

FIG. 4 illustrates an improved fast channel change of IPTV according to one embodiment of the invention;

FIG. 5 illustrates an exemplary flow diagram of implementing an IPTV channel change using two multimedia streams of traffic according to one embodiment of the invention;

FIG. 6 is a block diagram illustrating an exemplary network element that can implement an IPTV channel change using two multimedia streams of traffic as used in FIG. 1 according to one embodiment of the invention;

FIG. 7 is a block diagram illustrating an exemplary network element that can control an IPTV channel change to a first multimedia stream of an IPTV channel used in FIG. 4 according to one embodiment of the system.

### DETAILED DESCRIPTION

The following description describes methods and apparatus of controlling an Internet Protocol television (IPTV) channel change to a first multimedia stream of an IPTV channel, where the channel change is initiated by a set top box coupled to the network device. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams.

The techniques shown in the figures can be implemented using code and data stored and executed on one or more electronic devices (e.g., an end station, a network element, etc.). Such electronic devices store and communicate (internally and/or with other electronic devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, router with a border gateway function, residential gateway, media gateway, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, palm tops, mobile phones, smartphones, multimedia phones, Voice Over Internet Protocol (VOIP) phones, portable media players, GPS units, gaming systems, set-top boxes, etc.) access content/services provided over the Internet and/or content/services provided on virtual private networks (VPNs) overlaid on the Internet. The content and/or services are typically provided by one or more end stations (e.g., server end stations) belonging to a service or content provider or end stations participating in a peer to peer service, and may include public webpages (free content, store fronts, search services, etc.), private webpages (e.g., username/password accessed webpages providing email services, etc.), corporate networks over VPNs, etc. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Network elements are commonly separated into a control plane and a data plane (sometimes referred to as a forwarding plane or a media plane). In the case that the network element is a router (or is implementing routing functionality), the control plane typically determines how data (e.g., packets) is to be routed. For example, the control plane typically includes one or more routing protocols (e.g., Border Gateway Protocol (BGP), Interior Gateway Protocol(s) (IGP) (e.g., Open Shortest Path First (OSPF), Routing Information Protocol (RIP), Intermediate System to Intermediate System (ISIS), etc.), Label Distribution Protocol (LDP), Resource Reservation Protocol (RSVP), etc.) that communicate with other network elements to exchange routes and select those routes based on one or more routing metrics.

Routes and adjacencies are stored in one or more routing structures (e.g., Routing Information Base (RIB), Label Information Base (LIB), one or more adjacency structures, etc.) on the control plane. The control plane programs the data plane with information (e.g., adjacency and route information) based on the routing structure(s). For example, the control plane programs the adjacency and route information into one or more forwarding structures (e.g., Forwarding Information Base (FIB), Label Forwarding Information Base (LFIB), and one or more adjacency structures) on the data plane. The data plane uses these forwarding and adjacency structures when forwarding traffic.

Each of the routing protocols downloads route entries to a main RIB based on certain route metrics (the metrics can be different for different routing protocols). Each of the routing protocols can store the route entries, including the route entries which are not downloaded to the main RIB, in a local RIB (e.g., an OSPF local RIB). A RIB module that manages the main RIB selects routes from the routes downloaded by the routing protocols (based on a set of metrics) and downloads those selected routes (sometimes referred to as active route entries) to the data plane. The RIB module can also cause routes to be redistributed between routing protocols.

For layer 2 forwarding, the network element can store one or more bridging tables that are used to forward data based on the layer 2 information in this data.

Typically, a network element includes a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network element through the line cards. The set of service cards can provide specialized processing (e.g., Layer 4 to Layer 7 services (e.g., firewall, IPsec, IDS, P2P), VoIP Session Border Controller, Mobile Wireless Gateways (GGSN, Evolved Packet System (EPS) Gateway), etc.). By way of example, a service card may be used to terminate IPsec tunnels and execute the attendant authentication and encryption algorithms.

A method and apparatus of controlling an Internet Protocol television (IPTV) channel change to a first multimedia stream of an IPTV channel, where the channel change is initiated by a set top box coupled to the network device is described. A network device receives a request from a set top box for a high-resolution multimedia stream from a device downstream and transmits a low-resolution multimedia stream upstream in place of the high-resolution multimedia stream request. The network device receives the low-resolution multimedia stream and forwards the low-resolution stream to the requesting set top box. The set top receives the low-resolution stream and displays this stream. Furthermore, the network device transmits the high-resolution multimedia stream request and receives the high-resolution multimedia stream.

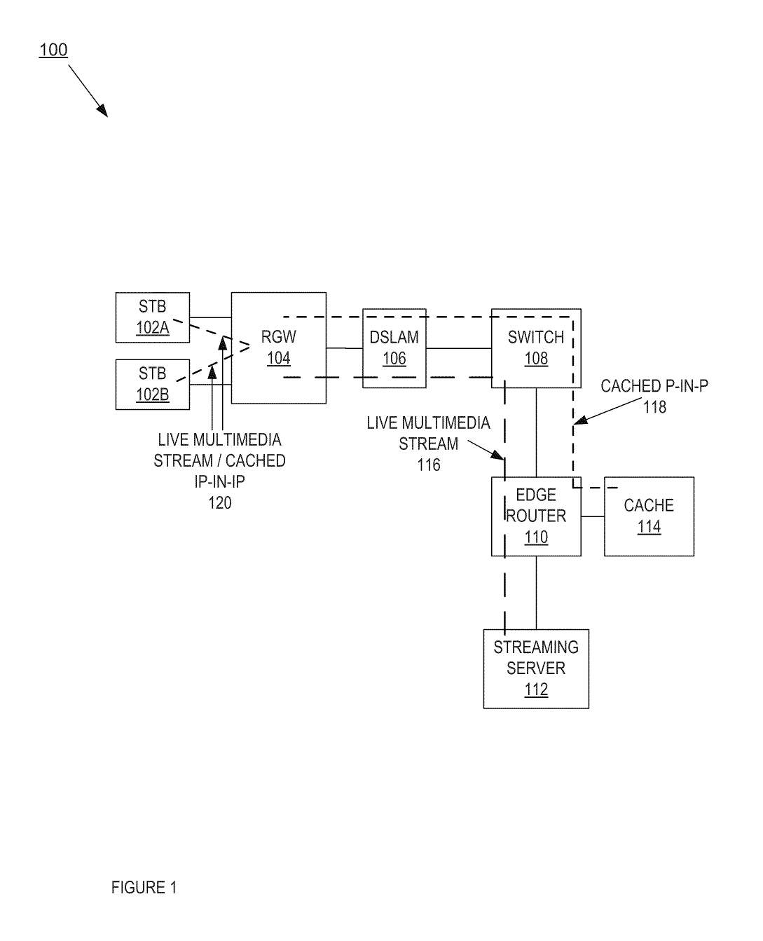

FIG. 1 illustrates a network 100 capable of delivering IPTV service to a set top box according to one embodiment of the invention. In FIG. 1, set top boxes 102A-B each can receive a multimedia stream or cached picture-in-picture stream 120 from network 100. In one embodiment, each set top box 102A-B is a device coupled to a television or other display and an external signal source (e.g., IPTV content) and converts the received signal into content that can be displayed on the television or other display. In alternative embodiments, set top boxes 102A-B represent a device that can receive a multimedia and/or cached picture-in-picture stream (e.g., personal computer, laptop, mobile media player, cellular phone, smartphone, television, digital video recorder, gaming console, media bridge, etc.). As used herein, downstream refers to a data traffic direction towards the set top boxes 102A-B. Upstream refers to a data traffic direction towards the IPTV content source (e.g., the streaming server 112 or cache 114).

In one embodiment, set top boxes 102A-B receive the multimedia stream/cached picture-in-picture stream 120 from a residential gateway 104. In one embodiment, multimedia stream 116 is a multicast multimedia stream transported over the network. While one embodiment, the multimedia stream 116 is multicast video stream for an IPTV service (standard definition video, high definition video, picture-in-picture video, etc.), in alternate embodiment, the multimedia stream 116 can be a difference multimedia service (video on demand, audio, webcasts, another multimedia service known in the art, and/or combination thereof). Furthermore, the multimedia stream 116 can be transported using be a protocol as known in the art (Motion Pictures Experts Group (MPEG)-1, MPEG-2, MPEG-4, h.264, Advanced Video Compression, etc.) to transport the multimedia data. In one embodiment, cached picture-in-picture stream 118 is a low-resolution version of a corresponding high or standard definition stream that is cached on the cache 114. Cache 114 is discussed further below. In one embodiment, the cached picture-in-picture stream 118 can be a unicast or multicast picture-in-picture stream. For example and in one embodiment, a cached picture-in-picture stream 118 is a stream that is about ten percent the bit rate of the corresponding standard definition stream (e.g., a 5 Mbps stream) or high definition stream (e.g., a 10 Mbps stream). In alternate embodiments, the cached picture-in-picture stream 118, the standard definition stream, and the high definition stream can have higher or lower data rates.

As mentioned above, set top box 102A-B receives the multimedia stream or cached picture-in-picture stream 120 from residential gateway 104. In one embodiment, a residential gateway 104 is a customer premise equipment (CPE) that provides services to other devices in the premise. In one embodiment, residential gateway 104 forwards the multimedia stream/cached picture-in-picture stream 120 to set top boxes 102A-B. The multimedia stream/cached picture-in-picture stream 120 forwarded to set top boxes 102A-B can be the same or different stream. For example and in one embodiment, set top box 102A may be watching a movie and set top 102B box can be watching a sports event.

Each set top box 102A-B requests a multimedia stream (e.g., an IPTV multimedia stream by transmitting a request to watch that stream towards router 110. In one embodiment, the transmitted request is sent via residential gateway 104 to Digital Subscriber Line Access Multiplexer (DSLAM) 106. DSLAM 106 forwards the request to switch 108, which in turn forwards the request to edge router 110. In one embodiment, edge router 110 is a router that is at the edge of a service providers network. For example and in one embodiment, edge router 110 is a router that couples a network service provider with the IPTV service provider.

In one embodiment, edge router 110 couples to cache 114 and streaming server 112. In this embodiment, edge router 110 can either fulfill the request for the service by forwarding either the cached picture-in-picture stream 118 from cache 114 or the requested multimedia stream from the streaming service 112. In this embodiment, the streaming server 112 is one or more servers that provide the IPTV content (IPTV channels, standard definition multimedia streams, high definition multimedia streams, picture-in-picture multimedia stream, video on demand, etc.). In one embodiment, streaming server 112 streams some or all of the multimedia streams supported by the IPTV service to edge router 110. In this embodiment, edge router 110 determines whether to forward these multimedia streams downstream towards set top boxes 102A-B.

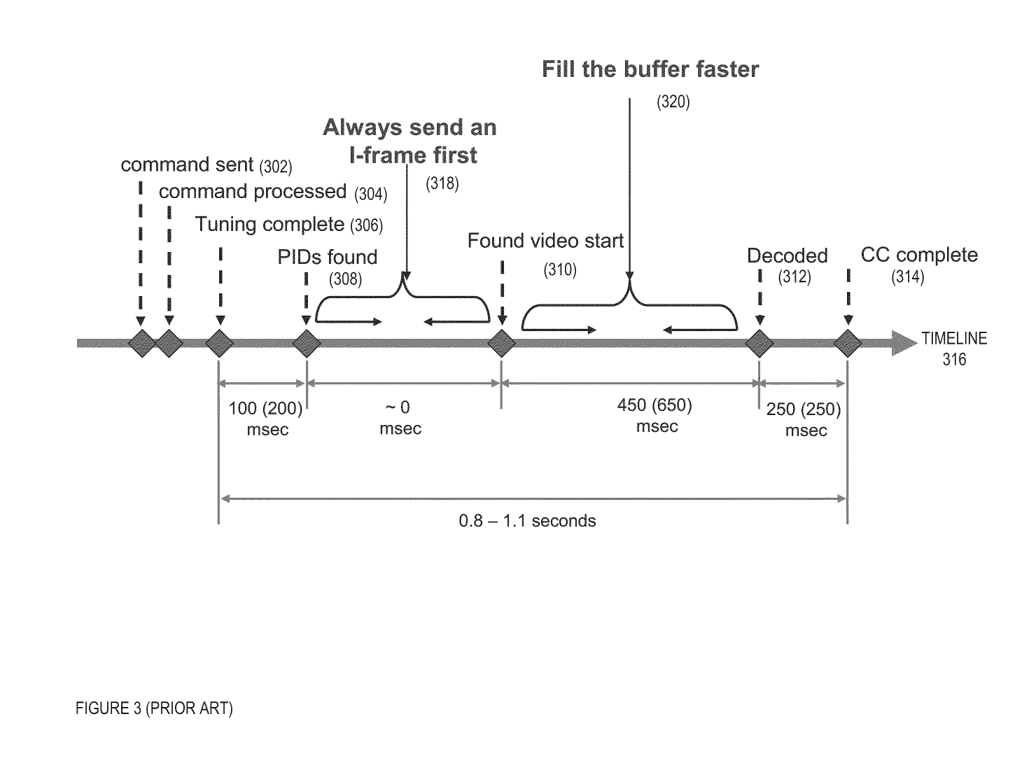

Cache 114 is a server that caches content that is used to support fast channel change for IPTV. In one embodiment, cache 116 caches the full set of multimedia streams supported by streaming server 112. In this embodiment, the cache 114 requires a large amount of resources (e.g., processing power, disk space), because storing this full set of multimedia streams is a resource intensive task. Using the fully cached multimedia stream is further described in FIG. 3 below.

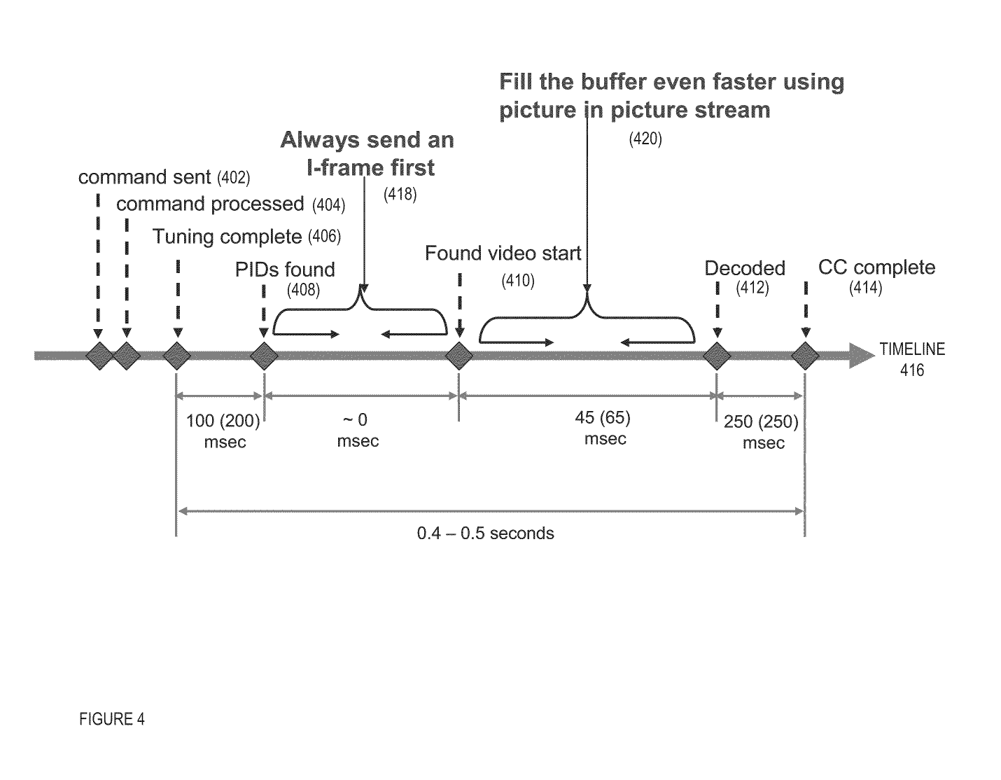

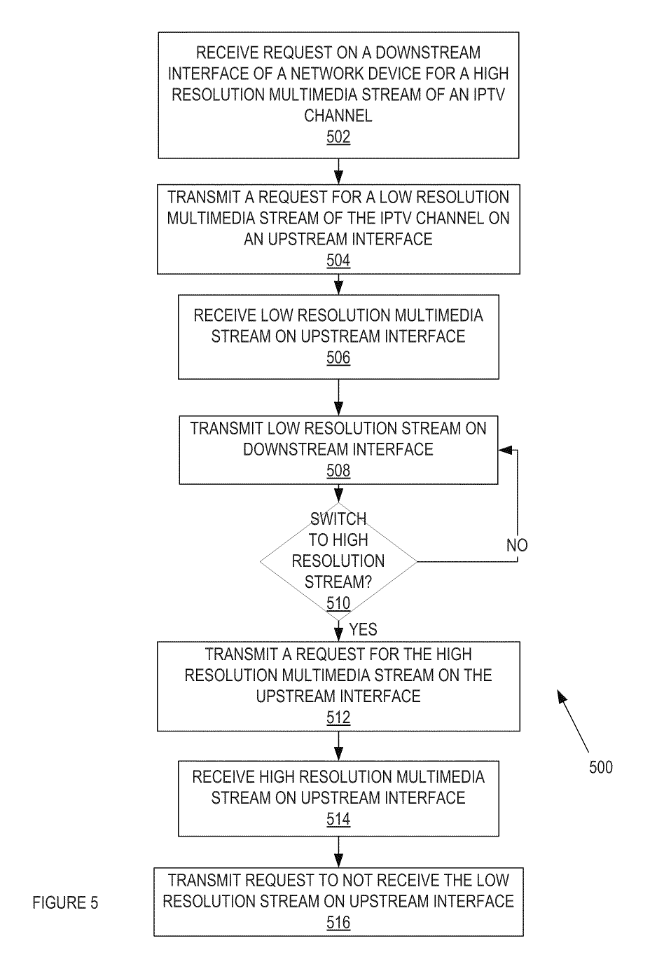

In an alternate embodiment, cache caches the picture-in-picture steams that correspond to the multimedia streams provided by streaming server 112. In this embodiment, the cache 114 has smaller resource requirements because the picture-in-picture multimedia stream is a bit stream that is approximately ten percent the size of the corresponding multimedia stream. In one embodiment, cache 114 is storage on the edge router 110. Using the cached picture-in-picture streams is further described in FIGS. 4 and 5 below.

As described above, two different types of streams can be transmitted to the set top boxes 102A-B: the cached picture-in-picture stream 118 or the multimedia stream 116. Which stream is delivered to the set top boxes depends on the type action taken on the request sent by the set top boxes 102A-B. In one embodiment, the requested multimedia stream is delivered to the set top box 102A-B. In another embodiment, a cached multimedia stream is initially delivered to the set top box 102A-B, followed later by requested multimedia stream. For example and in one embodiment, one (or more) of residential gateway 104, DSLAM 106, switch 108, and edge router 110 can select which of the two streams is sent to the requesting set top box 102A-B.

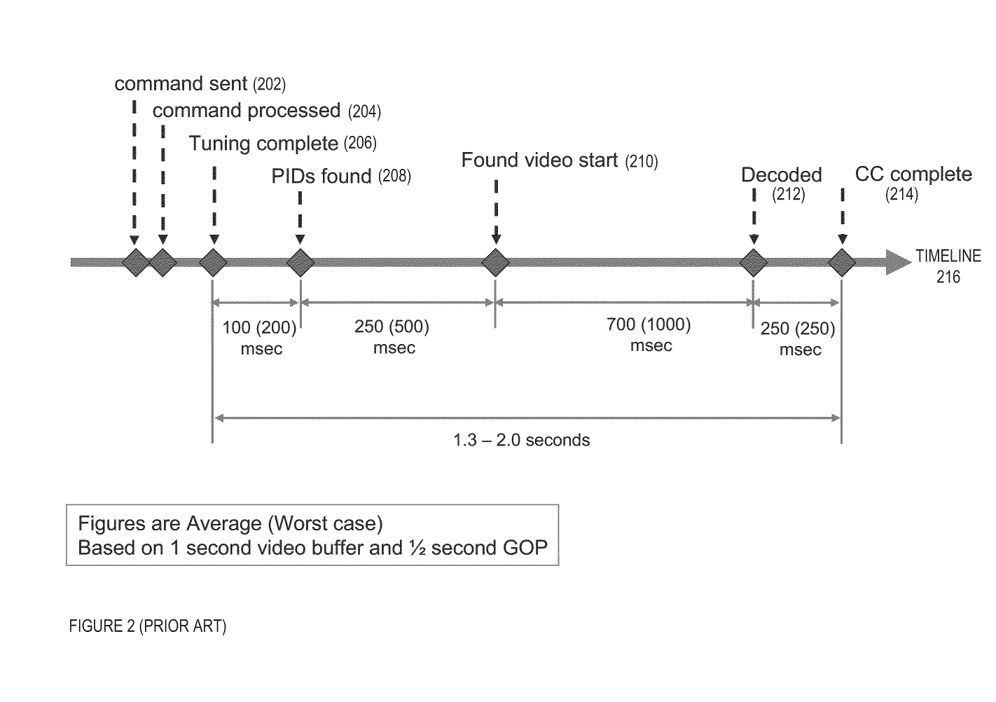

Before discussing how the two different streams are selected for the set top box 102A-B, how a set top box requests and displays a multimedia stream from an IPTV service is discussed. FIG. 2 (prior art) illustrates a timeline of a channel change for a standard implementation of IPTV. In this example, a channel change is measured from the time the set top box makes a request for a multimedia stream (e.g., a request to receive a multimedia stream for a television program) to the time the set top box starts to display the received multimedia stream in a display coupled to the set top box. The channel change times in the example given below is based on a set top box with a video buffer of one seconds worth of multimedia data and a group of pictures that is half a second long. A larger or smaller video buffer and/or group of pictures can shorten or lengthen the channel change times. In FIG. 2, the set top box sends a command (202) upstream that requests a multimedia stream. The sending of the request starts the measurement for the channel change time. In one embodiment, this multimedia stream can be a stream as described above or a cached picture-in-picture stream. This command is processed (204) by the router (e.g., the edge router 110 of FIG. 1 above) and the router sends the multimedia stream to the set top (206). At (206), the tuning to the new multimedia stream is complete.

After a short time lag (100 milliseconds on averages and up to 200 milliseconds in the worst case), the set top box determines the packet identifiers (PIDs) of the multimedia stream (208). For the set top box to begin processing the multimedia stream, the set top needs to find an initial I-frame of the multimedia stream. As is known in the art, an I-frame is an intra-coded picture frame, which does not depend on other frames. The set top box typically ignores the other encoded frames types until an I-frame appears in the multimedia stream. Finding that initial I-Frame (210), on average, takes 250 milliseconds and can be up to 500 milliseconds.

In addition, a buffer of multimedia data is typically needed before the set top box can start decoding the multimedia stream for display. In this example, the set top box fills its buffer (212) on average in 700 milliseconds, although this operation can take up to 1000 milliseconds. Once the buffer is full, the set top box decodes the buffer (212). This operation can take on average 250 milliseconds. Once the buffer is decoded, the channel change is complete. In this example, the channel change takes 1.3-2.0 seconds.

A channel change of over one second can be a long time for a user of the IPTV system. One way to speed up the channel change time is to cache the different multimedia streams. FIG. 3 (prior art) illustrates a channel change for a fast channel change of IPTV that reduces the channel change by caching the multimedia streams in a cache (e.g., cache 114 of FIG. 1 above). In this example, the command sent step (302), command processed step (304), tuning complete step (306), and PIDs found (308) are the same as steps 202, 204, 206, and 208, respectively, as described in FIG. 2 above. The channel change times in the example given below is based on a set top box with a video buffer of one seconds worth of multimedia data and a group of pictures that is half a second long. A larger or smaller video buffer and/or group of pictures can shorten or lengthen the channel change times. However, in this example, instead of just forwarding the multimedia stream from the streaming server as in FIG. 2 above, the edge router instead starts forwarding the cached multimedia stream from a cache (e.g., cache 114 in FIG. 1 above), starting with an I-frame. By starting this multimedia stream with an I-frame from the cache, the time it takes for the set top box to find the initial I-frame (318) of the start of the multimedia stream is down to zero milliseconds (310), instead of the 250-500 milliseconds as in FIG. 2 above. In addition, the router can transmit the cached multimedia stream a bit rate higher than would normally be done by the router with a streamed multimedia stream. This allows the set top box to fill the buffer (320) more quickly than in FIG. 2. For example, by the router transmitting the cached multimedia stream at up to thirty percent faster than normal, the set top box fills the buffer on average in about 450 milliseconds and can be up to 650 milliseconds. The set top box decodes the buffer multimedia stream (312) with same times as in step 212 of FIG. 2 above. As mentioned above, in this example, the cache that is used to store the full I-frames will have large resource requirements.

Overall, the channel change of the fast channel change is 0.8-1.1 seconds. In one embodiment, a way to reduce the channel change time is make use of the picture-in-picture multimedia stream that corresponds to the multimedia stream requested by the set top box. In one embodiment, an IPTV provider will have a picture-in-picture stream for each multimedia stream to provide a picture-in-picture service. As described above, a picture-in-picture stream is a much smaller bit stream than the corresponding multimedia stream. For example and in one embodiment, a picture-in-picture stream is approximately ten percent the size of the corresponding multimedia stream (e.g., 5-10 Mbps). Because the picture-in-picture stream is a smaller bit stream, processing the picture-in-picture stream takes less time and resources than processing the corresponding multimedia stream.

FIG. 4 illustrates an improved fast channel change of IPTV employing the picture-in-picture multimedia stream according to one embodiment of the invention. In FIG. 4, the command sent step (402), command processed step (404), tuning complete step (406), and PIDs found (408) are the same as steps 202, 204, 206, and 208, respectively, in described in FIG. 2 above. The channel change times in the example given below is based on a set top box with a video buffer of one seconds worth of multimedia data and a group of pictures that is half a second long. A larger or smaller video buffer and/or group of pictures can shorten or lengthen the channel change times. Similar to step 318 above, at step 418, the edge router (edge router 110 of FIG. 1 above) transmits the first I-frame of the cached multimedia stream. However, in this embodiment, the edge router sends to the I-frame of the picture-in-picture stream that corresponds to the multimedia stream that the set top box requested. How the picture stream to the set top box is switched from the requested multimedia stream to a corresponding picture-in-picture stream is discussed below in FIG. 5. The set top box receives this initial I-frame, which starts the multimedia processing (410). As above, the set top box fills a buffer in order to start displaying the stream. Because the set top box receives a picture-in-picture stream at a low bit rate and not a multimedia stream at a higher bit rate, the set top box fills the buffer much quicker than in FIG. 3. In another embodiment, the router can transmit the cached picture-in-picture stream at a higher bit rate that is normally transmitted with the streamed picture-in-picture multimedia stream from the picture-in-picture service. For example and in one embodiment, the set top box, on average, fills the buffer in 45 milliseconds and can be up to 65 milliseconds. In this example, by using the picture-in-picture stream, the buffer filling can happen in an approximately order of magnitude faster than the using the corresponding multimedia stream. In another embodiment, because the cached picture-in-picture stream is a much smaller stream that the cached multimedia stream used in FIG. 3, the router can transmit the cached picture-in-picture stream much faster and possibly bring the time it takes to fill up the set top box buffer done to ten milliseconds. The set top box decodes the picture-in-picture stream (412), on average, in about 250 milliseconds. Overall, in one embodiment, the time for the channel change is about 0.4-0.5 seconds. This represents a 0.3-1.6 second improvement over the channel change times illustrated in FIGS. 2 and 3 above.

As mention above, to achieve an improved faster channel change of FIG. 4, for a particular requested multimedia stream, a picture-in-picture stream is initially sent to the set top box. The set top box decodes and displays the picture-in-picture stream for a short period as the requested multimedia stream is also transmitted to the set top box. In one embodiment, this is achieved by a device between the set top box and edge router controlling which stream is sent to the set top box during an IPTV channel change. FIG. 5 illustrates an exemplary flow diagram of a method 500 of implementing an IPTV channel change using two multimedia streams of traffic according to one embodiment of the invention. While in one embodiment, the residential gateway can perform this method 500, in alternate embodiments, the set top box, DSLAM, switch, and/or edge router can perform the method 500. For example and in one embodiment, one of set top box 102A-B, residential gateway 104, DSLAM 106, switch 108, and edge router 112 of FIG. 1 can perform method 500.

In FIG. 5, method 500 receives a request on a downstream interface of a network device for a high-resolution multimedia stream of an IPTV channel at block 502. In this embodiment, a downstream interface is an interface that can transmit/receives data traffic downstream. In one embodiment, the high-resolution multimedia stream is a higher resolution stream that a picture-in-picture stream (e.g., a stand definition or high definition multimedia stream). While one embodiment, the multimedia stream is multicast video stream for an IPTV service (standard definition video, high definition video, etc.), in alternate embodiment, the multimedia stream can be a difference multimedia service (video on demand, audio, webcasts, another multimedia service known in the art, and/or combination thereof). In one embodiment, the request is based on a protocol as known in the art for requesting multimedia streams (e.g., an Internet Group Management Protocol (IGMP) report, Multicast Listener Directory (MLD), Protocol Independent Multicast (PIM) join, etc.). In one embodiment, method 500 receives the request from a set top box, such as set top box 102A-B as described above in FIG. 1.

At block 504, method 500 transmits a request for a low-resolution multimedia stream of the IPTV channel on an upstream interface. In this embodiment, an upstream interface is an interface that can transmit/receive data traffic upstream. In one embodiment, method 500 transmits a request for a an Internet Group Management Protocol (IGMP) report. Multicast Listener Directory (MLD), Protocol Independent Multicast (PIM) join, etc., or other type of request for a picture-in-picture multimedia stream that corresponds to the multimedia stream requested at block 502. For example and in one embodiment, a set top box sends a request to receive a high definition multimedia stream for channel 2 of an IPTV service. In this embodiment, a device performing method 500 (residential gateway, DSLAM, switch, edge router, etc.) receives this request and transmits a request for the corresponding picture-in-picture multimedia stream for IPTV channel 2.

In one embodiment, method 500 sends the request for the picture-in-picture multimedia stream to the edge router. In this embodiment, the picture-in-picture multimedia stream is stored in the cache (e.g., cache 114 of FIG. 1). While in one embodiment, the cache is a component of the edge router, in alternate embodiments, the cache is separate from the edge router (e.g., a caching server, coupled to the edge router, a service that is part of the streaming services, etc.).

At block 506, method 500 receives the low-resolution multimedia stream on an upstream interface. In one embodiment, method 500 receives the picture-in-picture multimedia stream requested at block 504 above. Method 500 transmits this received low-resolution multimedia stream out the downstream interface at block 508. For example and in one embodiment, method 500 transmits the picture-in-picture multimedia stream to the requesting set top box out the downstream interface that method 500 received the initial request on, in block 502. In this embodiment, the requesting set top box receives the low-resolution multimedia stream and can buffer, decode, and display this stream.

While at this point the set top box has a multimedia stream to display, method 500 still has to switch over to the original multimedia stream that was requested. Overall, method 500 accomplishes the switchover by stopping the transmission of the lower-resolution multimedia stream and starting the transmission of the higher-resolution multimedia stream to the requesting set top box. At block 510, method 500 determines if switch to the high-resolution multimedia stream should be performed. In one embodiment, method 500 can make this determination based on a time period from receiving the initial high-resolution multimedia request, set top box capability, number of low-resolution I-frames transmitted, number of low-resolution group of pictures transmitted, number of low resolution bytes transmitted, etc. For example and in one embodiment, method 500 switches over the transmission of the low to high-resolution multimedia streams after a two second time period. If method 500 does not switch to the high-resolution stream, execution proceeds to block 508.

If method 500 does not switch to the high-resolution stream, at block 512, method 500 transmits a request for the high-resolution multimedia stream on the upstream interface. In one embodiment, method 500 transmits the request for the same high resolution that was requested at block 502 above. For example and in one embodiment, if method 500 received a request for a high definition multimedia stream of IPTV channel 2, method 500 transmits this request. Method 500 receives the high-resolution multimedia stream at block 514.

At block 516, method 500 transmits a request to drop the low-resolution multimedia stream on the upstream interface. In one embodiment, method 500 transmits an IGMP/MLD drop to the edge router, which in turn stops transmitting the requested picture-in-picture multimedia stream. Method 500 transmits the received high-resolution multimedia stream out the downstream interface at block 518.

How method 500 switches over the transmission from the low to high-resolution multimedia stream can be done in a variety of ways. In one embodiment, method 500 performs the blocks 512-516 above in any order. By transmitting the request for and receiving the high-resolution multimedia stream while still transmitting the low-resolution multimedia stream, method 500 can overlap the two streams. Alternatively, method can drop the low-resolution multimedia stream (block 516) and request/transmit the high-resolution multimedia stream (block 512-514) afterwards.

In one embodiment, because the low-resolution multimedia stream is much smaller than the high-resolution multimedia stream, method 500 can afford to receive both multimedia streams together and minimize possible disruption of switching over from the transmission of the low to high-resolution multimedia stream.

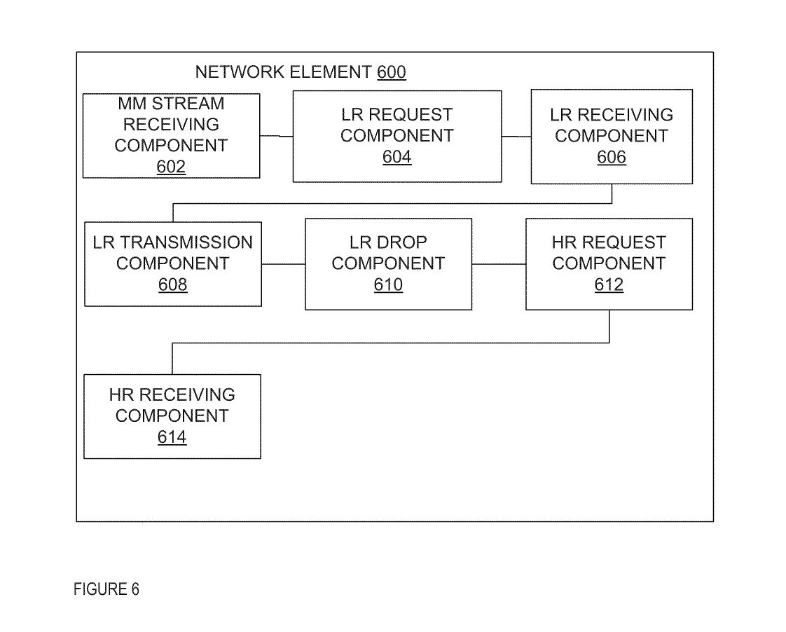

FIG. 6 is a block diagram illustrating an exemplary network element 600 that can implement an IPTV channel change using two multimedia streams of traffic as used in FIG. 1 according to one embodiment of the invention. In FIG. 6, network element 600 includes multimedia stream receiving component 602, low-resolution request component 604, low resolution receiving component 606, low-resolution transmission component 608, low-resolution drop component 610, high-resolution request component 612, high resolution receiving component 614, switch component 616, and high-resolution transmission component 618. Multimedia stream receiving component 602 receives the high-resolution request from the set top box as described in FIG. 5, block 502. Low-resolution request component 604 transmits the low-resolution request as described in FIG. 5, block 504. Low resolution receiving component 606 receives the low-resolution multimedia stream as described in FIG. 5, block 506. Low-resolution transmission component 608 transmits the low-resolution multimedia stream as described in FIG. 5, block 508. Low-resolution drop component 610 sends a request to drop the low-resolution multimedia stream as described in FIG. 5, block 516. High-resolution request component 612 transmits a request for the high-resolution multimedia stream as described in FIG. 5, block 512. High resolution receiving component 614 receives for the high-resolution multimedia stream as described in FIG. 5, block 514. Switch component 616 determines whether to switchover to transmission of the high-resolution multimedia stream as described in FIG. 5, block 510. High-resolution transmission component 618 transmits the high-resolution multimedia stream as described in FIG. 5, block 518.

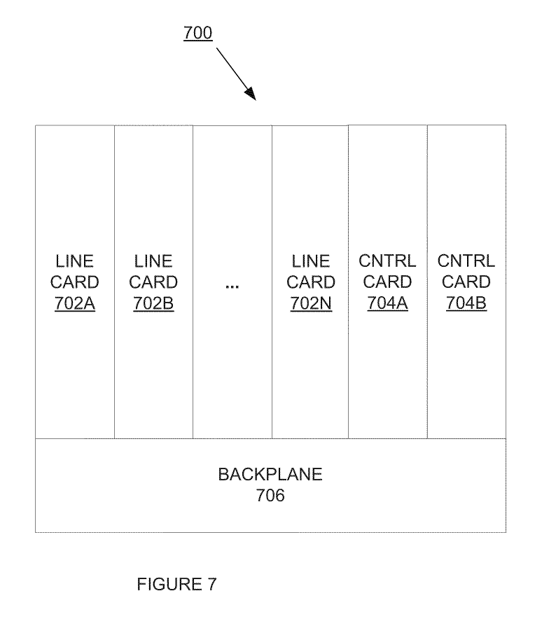

FIG. 7 is a block diagram illustrating an exemplary network element that can control an IPTV channel change to a first multimedia stream of an IPTV channel used in FIG. 4 according to one embodiment of the system. In FIG. 7, backplane 706 couples to line cards 702A-N and controller cards 704A-B. While in one embodiment, controller cards 704A-B control the processing of the traffic by line cards 702A-N, in alternate embodiments, controller cards 704A-B, perform the same and/or different functions (controlling IPTV channel change, etc.). Line cards 702A-N process and forward traffic according to the policies received from controller cards 704A-B. In one embodiment, line cards 702A-N process data as described in FIGS. 4-6. In another embodiment, line cards 702A-N control an IPTV channel change as described in FIG. 5. It should be understood that the architecture of the network element 700 illustrated in FIG. 7 is exemplary, and different combinations of cards may be used in other embodiments of the invention.

### Alternative Embodiments

The embodiments illustrated for controlling an Internet Protocol television (IPTV) channel change to a first multimedia stream of an IPTV channel have been shown with respect to a network element such as a residential gateway that exists in the network infrastructure. However, embodiments of the invention are not limited to controlling an IPTV channel change with residential gateway. Alternative embodiment may have the IPTV channel change in other devices (DSLAM, switch, edge router, etc.). Alternatively, a separate device could control the channel change as described above.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method of controlling, by a network device that provides access to a first multicast stream, an Internet Protocol television (IPTV) channel change to a first multimedia stream of an IPTV channel, the channel change initiated by a set top box coupled to the network device, the method comprising the steps of:
receiving a request for the first multimedia stream from the set top box;
transmitting, with the network device, a request for a second multimedia stream to an edge router coupled to an IPTV service, wherein the second multimedia stream corresponds to the same IPTV channel as the first multimedia stream and the second multimedia stream has a lower resolution that the first multimedia stream;
receiving the second multimedia stream;
transmitting the second multimedia stream to the set top box;
transmitting a request for the first multimedia stream to the edge router;
receiving the first multimedia stream; and,
transmitting the first multimedia stream to the set top box.

2. The method of claim 1, wherein the method further comprises the steps of:
transmitting a request to drop the second multimedia stream to the edge router.

3. The method of claim 1, wherein the method further comprises the steps of:
determining when to switch to the transmitting of the first multimedia stream from the transmitting of the second multimedia stream.

4. The method of claim 2, wherein the determining is based on a number of bytes of the second multimedia stream that has been transmitted.

5. The method of claim 1, wherein the second multimedia stream is cached in a caching network device.

6. The method of claim 1, wherein the second multimedia stream is a picture-in-picture multimedia stream.

7. The method of claim 1, wherein the first multimedia stream is selected from a group consisting of a high definition multimedia stream and a standard definition multimedia stream.

8. The method of claim 1, wherein the first network element is selected from a group consisting of a multicast snooping switch and a multicast router.

9. The method of claim 1, wherein the first multimedia stream is selected from a group consisting of a multicast stream and a unicast stream.

10. The method of claim wherein the network device is the set top box.

11. The method of claim 8, wherein the step of transmitting the second multimedia device comprises the steps of:
buffering the second multimedia stream;
decoding the buffered second multimedia stream; and,
outputting the decoded second multimedia stream to a display device coupled to the set top box.

12. The method of claim 1, wherein the first received frame of the second multimedia stream is an I-frame.

13. A network element adapted to control access by a set top box to a first multimedia stream of an Internet Protocol television (IPTV) channel, wherein the set top box is coupled to the network element and initiates an IPTV channel change to the first multimedia stream, the network element comprising:
a multimedia stream request component to receive the request for the first multimedia stream from the set top box;
a low-resolution request component to transmit a request for a second multimedia stream to an edge router coupled to an IPTV service and the second multimedia stream corresponds to the same IPTV channel as the first multimedia stream and the second multimedia stream has a lower resolution that the first multimedia stream;
a low-resolution receiving component to receive the second multimedia stream;
a low-resolution transmission component to transmit the second multimedia stream to the set top box;
a high-resolution request component to transmit a request for the first multimedia stream to the edge router;
a high-resolution receiving component to receive the first multimedia stream; and,
a high-resolution transmission component to transmit the first multimedia stream to the set top box.

14. The network element of claim 13, further comprising:
a low-resolution drop component to transmit a request to drop the second multimedia stream to the edge router.

15. The network element of claim 13, further comprising:
a switch component to determine when to switch to the transmitting of the first multimedia stream from the transmitting of the second multimedia stream.

16. The network element of claim 15, wherein the switch component determines when to switch transmitting the first multimedia stream based on a number of bytes of the second multimedia stream that has been transmitted.

17. The network element of claim 13, wherein the second multimedia stream is cached in a caching network device.

18. The network element of claim 13, wherein the second multimedia stream is a picture-in-picture multimedia stream.

19. The network element of claim 13, wherein the first multimedia stream is selected from a group consisting of a high definition multimedia stream and a standard definition multimedia stream.

20. The network element of claim 13, wherein the first received frame of the second multimedia stream is an I-frame.
